(19) United States
(12) Patent Application Publication
(10) Pub. No.: US 2012/0148928 A1
(43) Pub. Date: Jun. 14, 2012

(54) DIRECT OXIDATION FUEL CELL SYSTEM

(76) Inventors: Masaki Mitsui, Kyoto (JP); Takashi Akiyama, Osaka (JP); Junya Kusumoto, Nara (JP); Isamu Kawata, Osaka (JP)

(21) Appl. No.: 13/390,042

(22) PCT Filed: Feb. 25, 2011
(86) PCT No.: PCT/JP2011/001111

§ 371 Date: Feb. 10, 2012

(30) Foreign Application Priority Data
Jun. 29, 2010 (JP) 2010-148190

(51) Int. Cl. H01M 8/06

(52) U.S. Cl. 429/414

(57) ABSTRACT

A direct oxidation fuel cell system including: a fuel cell; a fuel supply portion for supplying a liquid fuel to a fuel inlet; an oxidant supply portion for supplying an oxidant to an oxidant inlet; an effluent tank for storing a fuel effluent; a fuel discharge path for leading the fuel effluent to the effluent tank; a gas-liquid separation mechanism for separating a part of product water from a fluid containing unconsumed oxidant and product water and discharging the remainder to outside; and a product water discharge path for leading the separated product water to the effluent tank. The gas-liquid separation mechanism has: a vent hole communicating with the oxidant outlet and outside; a porous filter for closing the vent hole; and a water-absorbent material for partially covering the surface of the porous filter on the oxidant outlet side.

### TECHNICAL FIELD

This invention relates to a direct oxidation fuel cell system including a direct methanol fuel cell, and more particularly, to an improvement in the gas-liquid separation mechanism for separating water from a fluid produced at the cathode of a fuel cell during power generation.

### BACKGROUND ART

Fuel cells are being put to practical use as the power source for automobiles, domestic cogeneration systems, etc. In recent years, the use of fuel cells as the power source for portable small electronic appliances such as notebook personal computers, cellular phones, and personal digital assistants (PDAs) is also under examination. Since fuel cells can generate power continuously if only they get refueled, they are expected to further increase the convenience of portable small electronic appliances.

Among fuel cells, direct oxidation fuel cells (DOFCs) generate electrical energy by directly oxidizing a fuel that is liquid at room temperature, so they can be easily miniaturized. Direct methanol fuel cells (DMFCs), which use methanol as the fuel, are superior to other direct oxidation fuel cells in energy efficiency and power output, and are regarded as the most promising among DOFCs.

A fuel cell includes a stack comprising a plurality of cells connected in series. Each cell includes: a membrane-electrode assembly comprising an electrolyte membrane and an anode and a cathode disposed on both sides of the electrolyte membrane, respectively; an anode-side separator in contact with the anode; and a cathode-side separator in contact with the cathode. The anode-side separator has a fuel flow channel for supplying a liquid fuel to the anode, while the cathode-side separator has an oxidant flow channel for supplying an oxidant to the cathode. The liquid fuel and the oxidant are supplied to the fuel cell by supply devices such as pumps.

The reactions at the anode and cathode of a DMFC are shown below. Oxygen introduced into the cathode is usually taken from the air.

Anode: CH₃OH+H₂O→CO₂+6H⁺+6e⁻

Cathode: (3/2)O₂+6H⁺+6e⁻→3H₂O

At the anode, methanol and water react to produce carbon dioxide. The fuel effluent containing the carbon dioxide and unreacted fuel is transported to an effluent tank. At the cathode, more water than consumed at the anode is produced. A part of the fluid containing water and unreacted oxygen is transported to an effluent tank.

The carbon dioxide discharged from the anode and the remaining part of the fluid (usually steam and oxygen) discharged from the cathode are released to outside. PTL 1 proposes that a filter for purifying the fluid to be released to outside be installed inside a pipe through which the fluid passes. Also, PTL 2 proposes that a water-absorbent sheet be used to absorb the steam discharged from the cathode to prevent the steam from affecting the nearby device.

### CITATION LIST

### Patent Literature(s)

[PTL 1] Japanese Laid-Open Patent Publication No. 2005-183014
[PTL 2] Japanese Laid-Open Patent Publication No. 2006-179470

### SUMMARY OF INVENTION

### Technical Problem

The fluid discharged to outside from the cathode contains steam. Thus, as in PTL 1, when the filter is installed in the pipe through which the fluid passes, condensed water accumulates inside the filter, gradually interfering with the passage of the fluid. As a result, the loss of the pressure for supplying the oxidant to the cathode increases, and the amount of power consumed by the oxidant supply device such as a pump increases.

Also, as in PTL 2, when the water-absorbent sheet is used to absorb the steam, condensed water is highly likely to accumulate in some areas, depending on the positional relation between the fluid circulation path and the water-absorbent sheet, eventually interfering with the passage of the fluid. Also, when the water-absorbent sheet is merely disposed next to the fuel cell, it is difficult to control the amount of steam discharged to outside. It is therefore difficult to control the amount of water collected into the effluent tank.

### Solution to Problem

The direct oxidation fuel cell system according to the invention includes: a fuel cell including at least one cell, a fuel inlet for introducing a liquid fuel, a fuel outlet for discharging a fuel effluent, an oxidant inlet for introducing an oxidant, and an oxidant outlet for discharging a fluid containing unconsumed oxidant and product water; a fuel supply portion for supplying the liquid fuel to the fuel inlet; an oxidant supply portion for supplying the oxidant to the oxidant inlet; an effluent tank for storing the fuel effluent and a part of the product water; a fuel discharge path for leading the fuel effluent to the effluent tank; a gas-liquid separation mechanism for separating a part of the product water from the fluid and discharging the remainder to outside; and a product water discharge path for leading the separated product water to the effluent tank.

The gas-liquid separation mechanism has: a vent hole communicating with the oxidant outlet and outside; a porous filter for closing the vent hole; and a water-absorbent material for partially covering the surface of the porous filter on the oxidant outlet side.

### Advantageous Effects of Invention

The invention can suppress an increase in the loss of the pressure for supplying the oxidant to the cathode.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a schematic diagram showing the structure of a direct oxidation fuel cell system according to one embodiment of the invention;

FIG. 2 is a sectional view of a fuel cell included in the system perpendicular to the electrode plane;

FIG. 3 is a schematic diagram showing the structure of a gas-liquid separation mechanism included in the system;

FIG. 4 is a schematic diagram showing the structure of a filter portion included in the gas-liquid separation mechanism;

FIG. 5 is a schematic diagram showing the relationship between the gas-liquid separation mechanism included in the system and a suction pump;

FIG. 6A is a schematic diagram showing the structure of an effluent tank included in the gas-liquid separation mechanism; and

FIG. 6B is a sectional view of the effluent tank taken along the line VIb-VIb.

### DESCRIPTION OF EMBODIMENTS

With reference to FIG. 1, the direct oxidation fuel cell system of the invention is described.

A fuel cell system 1 includes a fuel cell 2, which has: a body 2a; a fuel inlet 2b for introducing a liquid fuel; a fuel outlet 2c for discharging a fuel effluent; an oxidant inlet 2d for introducing an oxidant; and an oxidant outlet 2e for discharging a fluid containing unconsumed oxidant and product water. The body 2a usually includes a stack of two or more cells connected electrically in series.

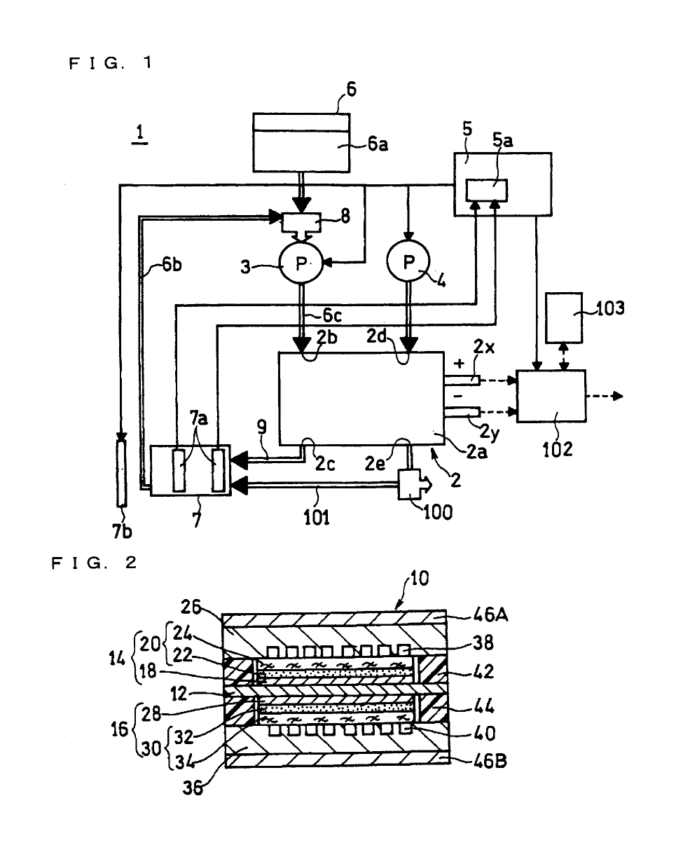

First, with reference to FIG. 2, the structure of a cell is described.

A cell 10 is a direct methanol fuel cell, which includes a polymer electrolyte membrane 12 and an anode 14 and a cathode 16 disposed so as to sandwich the polymer electrolyte membrane 12. The polymer electrolyte membrane 12 has hydrogen ion conductivity. The anode 14 is supplied with methanol as the fuel. The cathode 16 is supplied with air as the oxidant.

In the laminating direction of the anode 14, the polymer electrolyte membrane 12, and the cathode 16, an anode-side separator 26 is laminated on the anode 14, and an end plate 46A is further disposed on the anode-side separator 26. Also, a cathode-side separator 36 is laminated on (below in the figure) the cathode 16, and an end plate 46B is further disposed on the cathode-side separator 36. When two or more cells 10 are stacked, the end plates 46A and 46B are not provided for each cell, and each of the end plates 46A and 46B is provided at each end of the cell stack in the stacking direction. The respective end plates function as current collector plates which deliver power to output terminals 2x and 2y of the fuel cell, and the power is transmitted to an external load (not shown) or a storage battery 103 via a DC/DC converter 102.

Between the anode-side separator 26 and the polymer electrolyte membrane 12, a gasket 42 is disposed around the anode 14. Between the cathode-side separator 36 and the polymer electrolyte membrane 12, a gasket 44 is disposed around the cathode 16. The gaskets 42 and 44 prevent the fuel and the oxidant from leaking from the anode 14 and the cathode 16, respectively.

The two end plates 46A and 46B are clamped with bolts, springs, etc., not shown, so as to press the respective separators and the MEA (Membrane Electrode Assembly), to form the cell 10.

The anode 14 includes an anode catalyst layer 18 and an anode diffusion layer 20. The anode catalyst layer 18 is in contact with the polymer electrolyte membrane 12. The anode diffusion layer 20 includes an anode porous substrate 24 subjected to a water-repellent treatment, and an anode water-repellent layer 22 formed on a surface thereof and made of a highly water-repellent material. The anode water-repellent layer 22 and the anode porous substrate 24 are laminated in this order on the face of the anode catalyst layer 18 opposite to the face in contact with the polymer electrolyte membrane 12.

The cathode 16 includes a cathode catalyst layer 28 and a cathode diffusion layer 30. The cathode catalyst layer 28 is in contact with the face of the polymer electrolyte membrane 12 opposite to the face in contact with the anode catalyst layer 18. The cathode diffusion layer 30 includes a cathode porous substrate 34 subjected to a water-repellent treatment, and a cathode water-repellent layer 32 formed on a surface thereof and made of a highly water-repellent material. The cathode water-repellent layer 32 and the cathode porous substrate 34 are laminated in this order on the face of the cathode catalyst layer 28 opposite to the face in contact with the polymer electrolyte membrane 12.

A laminate comprising the polymer electrolyte membrane 12, the anode catalyst layer 18, and the cathode catalyst layer 28 is the power generation area of the fuel cell, and is called a CCM (Catalyst Coated Membrane). Also, the MEA is a laminate of the CCM, the anode diffusion layer 20 and the cathode diffusion layer 30. The anode diffusion layer 20 and the cathode diffusion layer 30 uniformly diffuse the fuel and oxidant supplied to the anode 14 and the cathode 16, while smoothly removing the product water and carbon dioxide.

The face of the anode-side separator 26 in contact with the anode porous substrate 24 has a fuel flow channel 38 for supplying the fuel to the anode 14. The fuel flow channel 38 comprises, for example, a recess or groove formed in the above-mentioned contact face, which is open toward the anode porous substrate 24. The fuel flow channel communicates with the fuel inlet 2b and the fuel outlet 2c of the fuel cell body 2a.

The face of the cathode-side separator 36 in contact with the cathode porous substrate 34 has an oxidant flow channel 40 for supplying the oxidant (air) to the cathode 16. The oxidant flow channel 40 also comprises, for example, a recess or groove formed in the above-mentioned contact face, which is open toward the cathode porous substrate 34. The oxidant flow channel communicates with the oxidant inlet 2d and the oxidant outlet 2e of the fuel cell body 2a.

The fuel cell system 1 further includes a fuel pump 3, which forms a fuel supply portion for supplying the liquid fuel to the fuel inlet, and an air pump 4, which forms an oxidant supply portion for supplying the oxidant to the oxidant inlet. The output of the fuel pump 3 and the air pump 4 is usually controlled by a predetermined control device 5. A microcomputer with an arithmetic unit 5a or the like is used as the control device 5.

The fuel pump 3 is connected to a fuel tank 6 containing a high concentration supply fuel 6a and an effluent tank 7. The supply fuel joins a fuel effluent 6b at a confluence portion 8 disposed upstream or downstream of the fuel pump. As a result, a liquid fuel 6c, whose concentration has been adjusted with the supply fuel 6a, is introduced into the fuel inlet 2b of the fuel cell. That is, the fuel pump 3 serves as a circulation pump for circulating the fuel effluent from the effluent tank 7 to the fuel inlet. The confluence portion 8 may be equipped with a mixing tank for temporarily storing the supply fuel 6a and the fuel effluent 6b and mixing them.

The fuel supply portion includes at least the fuel pump (first fuel pump) 3; however, at least one of the portion of the control device 5 for controlling the fuel pump 3, the fuel tank 6, and the confluence portion 8 where the supply fuel and the fuel effluent are joined may be construed as part of the fuel supply portion. Also, the fuel supply portion can additionally include a circulation pump (second fuel pump) for introducing the fuel effluent 6b from the effluent tank 7 to the confluence portion 8. The fuel supply portion can further include a supply fuel pump (third fuel pump) for controlling the amount of the supply fuel 6a introduced to the confluence portion 8, between the fuel tank 6 and the confluence portion 8. The output of the second and third fuel pumps can be controlled by the control device 5.

The liquid fuel 6c is introduced into the fuel flow channel from the fuel inlet 2b, passes through the flow channel while the fuel is being consumed, and is eventually discharged from the fuel outlet 2c as a fuel effluent containing carbon dioxide. Although the fuel effluent has a low fuel concentration, it contains unreacted fuel, and therefore, it is reused after separation of carbon dioxide. The fuel effluent is collected into the effluent tank 7 through a fuel discharge path 9, which connects the fuel outlet 2c and the effluent tank 7.

The method for separating carbon dioxide is not particularly limited. For example, carbon dioxide can be discharged to outside by providing the effluent tank 7 with a window and closing the window with a gas-liquid separation film which allows carbon dioxide to pass through. It is preferable to install a pair of electrodes 7a inside the effluent tank 7 as a sensor for measuring the amount of the liquid. In this case, the capacitance between the electrodes 7a can be used to monitor the amount of the liquid. It is also preferable to provide the effluent tank 7 with a temperature control unit 7b for controlling the temperature of the liquid inside or outside thereof.

The air pump 4 sucks the air from outside and introduces it to the oxidant inlet 2d of the fuel cell as the oxidant. The oxidant supply portion includes at least the air pump 4, but the portion of the control device 5 for controlling the air pump 4 can be construed as part of the oxidant supply portion. The air is introduced into the oxidant flow channel from the oxidant inlet 2d, passes through the flow channel while the oxygen is being consumed, and is eventually discharged from the oxidant outlet 2e as a fluid containing steam (product water). The discharged fluid is introduced into a gas-liquid separation mechanism 100 by the pressure of the air pump 4.

In the gas-liquid separation mechanism 100, a part of the product water is separated from the discharged fluid, and the remainder is discharged to outside. When methanol is used as the fuel, theoretically, 3 mol of water is produced at the cathode per 1 mol of water consumed at the anode. As such, by collecting 1 mol of water from the product water, the amount of water within the system can be theoretically maintained almost constant. The remaining 2 mol of water is released to outside via the gas-liquid separation mechanism 100. The separated product water is collected into the effluent tank 7 through a product water discharge path 101. The product water discharge path 101 connects the gas-liquid separation mechanism 100 and the effluent tank 7.

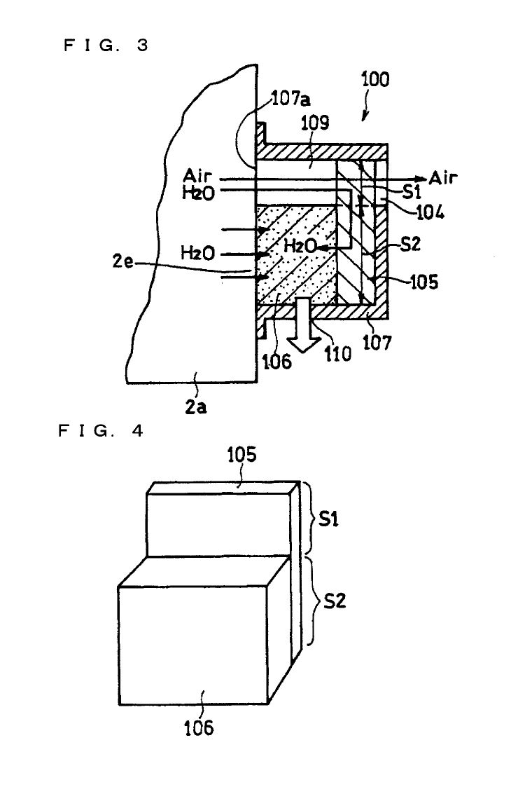

Referring now to FIG. 3, the structure of the gas-liquid separation mechanism 100 is described.

The gas-liquid separation mechanism 100 includes a vent hole 104 communicating with the oxidant outlet 2e and the outside, a porous filter 105 for closing the vent hole 104, and a water-absorbent material 106 for partially covering the surface of the porous filter 105 on the oxidant outlet side.

The vent hole 104 communicating with the oxidant outlet 2e and the outside is an opening for releasing the air containing unconsumed oxidant (unreacted oxygen). The vent hole 104 is positioned so that the fluid discharged from the cathode necessarily passes through the vent hole 104 before being discharged to outside. The vent hole 104 may be formed in the member of the fuel cell defining the oxidant outlet 2e, or may be formed in another member adjacent to that member.

In the case of FIG. 3, the oxidant outlet 2e of the fuel cell is defined by a member forming the fuel cell body 2a. The gas-liquid separation mechanism 100 is composed of a casing 107 and a filter portion (see FIG. 4), and the filter portion is composed of the porous filter 105 and the water-absorbent material 106. The casing 107 has a first opening 107a having almost the same shape as that of the oxidant outlet 2e and being directly connected to the oxidant outlet, and a second opening (vent hole) 104 facing the first opening. The second opening 104 is closed by the porous filter 105, but the water-absorbent material 106 is disposed in the casing 107 so as to partially cover the porous filter 105. Thus, the fluid discharged from the cathode is released to outside by passing mainly through the region S1 (hereinafter first region) of the porous filter 105 not covered with the water-absorbent material 106.

Since the fluid discharged from the cathode contains moisture, it condenses inside the pores of the porous filter 105, and the water accumulates within the porous filter 105. The water moves to the water-absorbent material 106 through the region S2 (second region) of the porous filter 105 covered with the water-absorbent material 106, for example, by capillarity. In the first region S1, since the air always flows, the water easily vaporizes. Therefore, in the first region S1, the water is unlikely to accumulate, and an increase in the loss of pressure of the air pump is suppressed.

That is, the water distribution is smallest in the first region S1 of the porous filter 105 and largest in the water-absorbent material 106. In this manner, by changing the water distribution inside the filter portion, it is possible to suppress an increase in the loss of the pressure for supplying the oxidant to the cathode, discharge a suitable amount of steam to outside, and collect a necessary amount of water into the effluent tank 107. Also, since the second opening 104 is closed by the porous filter 105, dust is prevented from entering the vicinity of the vent hole.

Although not particularly limited, the area of the second opening 104 is preferably smaller than the area of the first opening 107a, as illustrated in FIG. 3. Also, the water-absorbent material 106 is preferably disposed in the casing 107 so that it does not protrude into a cylindrical space 109 between the first opening 107a and the second opening 104. This makes it possible to prevent the air from passing through the second region S2 and prevent excessive vaporization of water. Also, this ensures a sufficient air circulation path, thus being effective in suppressing an increase in pressure loss.

When the amount of water supplied to the water-absorbent material 106 is beyond the maximum amount of water the water-absorbent material 106 can hold, the water moves downward in the gravity direction. Thus, for example, in order to collect the separated water into the effluent tank 107, a connection portion 110 communicating with the product water discharge path 101 is formed at a lower part of the casing 107 in the gravity direction. As such, the water is automatically collected into the effluent tank 107 by sequentially passing through the product water discharge path 101.

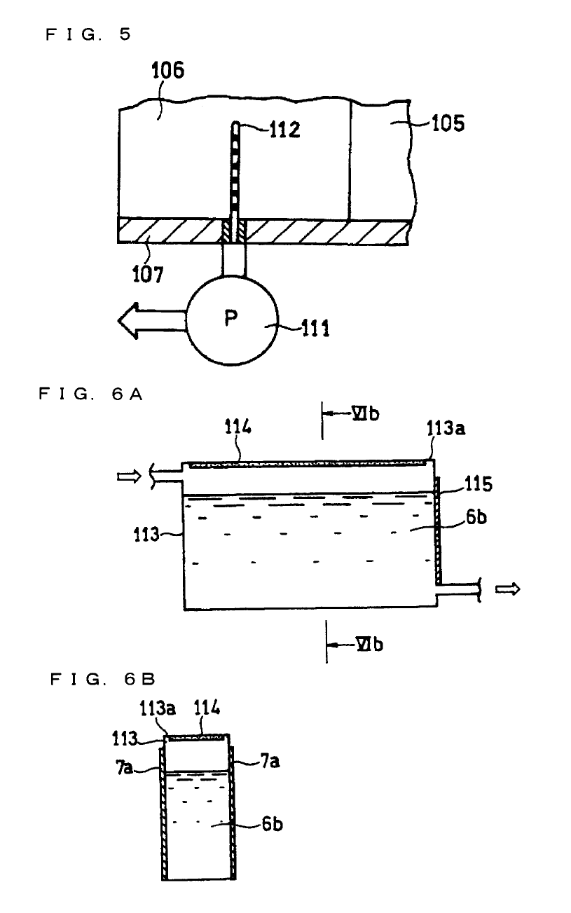

The product water discharge path 101 may be equipped with a suction pump 111 for sucking the water held in the water-absorbent material 106, as illustrated in FIG. 5. By allowing the suction pump 111 to sequentially suck the water from the water-absorbent material 106, the movement of the water from the porous filter 105 to the water-absorbent material 106 can be promoted. Also, regardless of the gravity direction, the water can be readily collected into the effluent tank 107. The suction pump 111 has, for example, a nozzle 112 to be inserted into the water-absorbent material 106, as illustrated in FIG. 5, and the water is fed to the suction pump from the nozzle 112.

The porous filter 105 can be made of a porous material which allows air to flow through. As such a material, a carbon sheet such as carbon foam, carbon paper, or carbon non-woven fabric is preferable.

The porous material 105 is preferably hydrophilic. For example, a carbon sheet which has been rendered moderately hydrophilic is desirable as the porous filter. Since a carbon sheet which has been rendered hydrophilic easily absorbs and releases water, water is unlikely to accumulate excessively in the porous filter.

Next, the specific structure of the carbon sheet is described.

For example, carbon foam can be produced by forming a mixture of a carbon powder and a binder into a sheet. The amount of binder can be adjusted as appropriate so that the sheet to be formed has a suitable pore volume. The powder physical properties of the carbon powder such as particle size distribution can also be selected as appropriate according to the desired average pore size or pore volume. As carbon paper or carbon non-woven fabric, commercially available one can be used.

The porous filter 105 preferably has pores with an average pore size of 0.4 to 1.2 mm, or 0.6 to 1.0 mm. An average pore size of 0.4 mm or more is advantageous to suppressing an increase in pressure loss, and an average pore size of 1.2 mm or less is advantageous to condensation of water. The average pore size can be measured, for example, by a perm porometer.

While the method for rendering a carbon sheet hydrophilic is not particularly limited, examples include methods using an argon plasma treatment. The preferable degree of hydrophilicity is such that the contact angle between the carbon sheet and water is 10° or less. The contact angle can be measured by a method such as the θ/2 method.

In order to allow sufficient air to flow through the filter portion to suppress an increase in pressure loss, it is important not to cover the whole surface of the porous filter 105 on the oxidant outlet side (the water-absorbent material side) with the water-absorbent material 106. The ratio of the surface of the porous filter 105 on the oxidant outlet side covered with the water-absorbent material 106 (i.e., the ratio of the area of the second region) is preferably 60 to 90%. If the ratio of the area of the second region S2 is too small, it takes time for the water to move from the porous filter 105 to the water-absorbent material 106, and the water tends to accumulate in the porous filter 105. As a result, the effect of suppressing an increase in the loss of the pressure for supplying the oxidant to the cathode decreases. On the other hand, if the ratio of the area of the second region S2 is too large, the area of the first region S1 decreases relatively, so the effect of suppressing an increase in pressure loss decreases as well.

The thickness of the porous filter 105 varies according to the kind of the porous material it is made of. For example, in the case of using a carbon sheet, the thickness of the porous filter 105 is preferably 3 to 6 mm, and more preferably 4 to 5 mm. If the porous filter 105 is too thick, the effect of suppressing an increase in the loss of the pressure for supplying the oxidant to the cathode decreases. If the porous filter 105 is too thin, the strength of the first region S1 not covered with the water-absorbent material in particular decreases.

The water-absorbent material 106 is desirably a material which can absorb and hold more water than the porous filter 105. Specifically, when immersed in a liquid, a preferable porous material absorbs the liquid into the pores to replace the air inside the pores, and readily releases the liquid when subjected to an external force. Also, the apparent volume of the preferable material does not increase even when it absorbs the liquid, and the rate of volume increase of the preferable material fully impregnated with the liquid is 5% or less. Preferable examples include natural sponge, synthetic resin sponge, pulp, and polypropylene/polyethylene composite fibers.

While the thickness of the water-absorbent material 106 (the thickness in the direction perpendicular to the face in contact with the porous filter) is not particularly limited, it is preferably, for example, 4 to 8 mm, since it is desirable to make the filter portion small while allowing it to hold a predetermined amount of water.

Referring now to FIGS. 6A and 6B, the structure of the effluent tank 7 is described.

The effluent tank 7 includes, for example, a container 113 having a window 113a at the top, and the window 113a is closed with a gas-liquid separation film 114 which allows carbon dioxide to pass through. The gas-liquid separation film 114 is preferably a water-repellent material. For example, a material prepared by fusing polytetrafluoroethylene particles into a sheet is used. Such a material allows steam to pass through. Thus, when the amount of liquid in the effluent tank 7 becomes excessive, the water can be released to outside as steam through the gas-liquid separation film, for example, by heating the effluent tank 107. On the other hand, if the amount of liquid in the effluent tank becomes too small, it is difficult to dilute the supply fuel. Thus, it is preferable to adjust the amount of liquid by cooling the effluent tank 107 or increasing the output of the suction pump 111 of the gas-liquid separation mechanism 100. The effluent tank 7 is preferably provided with a pair of electrodes 7a as a sensor for detecting the amount of liquid and a temperature sensor 115.

The fuel cell system of the invention is applicable to all direct oxidation fuel cells using a fuel that has a high affinity for water and is liquid at room temperature. Examples of such fuels include hydrocarbon liquid fuels such as methanol, ethanol, dimethyl ether, formic acid, and ethylene glycol.

In the case of using methanol, the concentration of the aqueous methanol solution fed to the anode of the fuel cell is preferably 1 mol/L to 8 mol/L. More preferably, the concentration of the aqueous methanol solution is 3 mol/L to 5 mol/L. The aqueous methanol solution used as the fuel is more advantageous to miniaturizing the fuel cell system as its concentration is higher. However, if the concentration of the aqueous methanol solution is too high, methanol crossover (MCO) may increase.

The invention is hereinafter described specifically by way of Examples. However, the invention is not to be construed as being limited to the following Examples.

### EXAMPLE 1

A supported anode catalyst comprising anode catalyst particles supported on a conductive support was prepared. A platinum-ruthenium alloy (atomic ratio 1:1) (average particle size: 5 nm) was used as the anode catalyst particles. Carbon particles with an average primary particle size of 30 nm were used as the support. The weight of the platinum-ruthenium alloy was set to 80% by weight of the total weight of the platinum-ruthenium alloy and the carbon particles.

A supported cathode catalyst comprising cathode catalyst particles supported on a conductive support was prepared. Platinum (average particle size: 3 nm) was used as the cathode catalyst particles. Carbon particles with an average primary particle size of 30 nm were used as the support. The weight of the platinum was set to 80% by weight of the total weight of the platinum and the carbon particles.

A 50-μm thick fluoropolymer membrane (a film composed basically of a perfluorosulfonic acid/polytetrafluoroethylene copolymer (H⁺ type), trade name “Nafion® 112”, available from E.I. Du Pont de Nemours & Co. Inc.) was used as the polymer electrolyte membrane.

### (Preparation of CCM)

### (Formation of Anode)

10 g of the supported anode catalyst, 70 g of a liquid dispersion containing a perfluorosulfonic acid/polytetrafluoroethylene copolymer (H⁺ type) (Nafion dispersion, “Nafion® 5 wt % solution”, available from E.I. Du Pont de Nemours & Co. Inc.), and a suitable amount of water were stirred and mixed with a stirring device. The resultant mixture was defoamed to prepare an ink for forming an anode catalyst layer.

The anode-catalyst-layer forming ink was sprayed onto a surface of the polymer electrolyte membrane by a spray method using an air brush, to form a rectangular anode catalyst layer of 40×90 mm. The dimensions of the anode catalyst layer were adjusted by masking. When the anode-catalyst-layer forming ink was sprayed, the polymer electrolyte membrane was attached and secured by reducing the pressure onto a metal plate whose surface temperature was adjusted with a heater. The anode-catalyst-layer forming ink was gradually dried during application. The thickness of the anode catalyst layer was 61 μm. The amount of Pt—Ru per unit area was 3 mg/cm².

### (Formation of Cathode)

10 g of the supported cathode catalyst, 100 g of a liquid dispersion containing a perfluorosulfonic acid/polytetrafluoroethylene copolymer (H⁺ type) (trade name “Nation® 5 wt % solution” as mentioned above), and a suitable amount of water were stirred and mixed with a stirring device. The resultant mixture was defoamed to prepare an ink for forming a cathode catalyst layer.

The cathode-catalyst-layer forming ink was applied onto the face of the polymer electrolyte membrane opposite to the face with the anode catalyst layer by the same method as that used to form the anode catalyst layer. In this manner, a rectangular cathode catalyst layer of 40×90 mm was formed on the polymer electrolyte membrane. The amount of Pt contained in the cathode catalyst layer per unit area was 1 mg/cm².

The anode catalyst layer and the cathode catalyst layer were disposed so that their centers (the point of intersection of diagonal lines of the rectangle) were positioned on a straight line parallel to the thickness direction of the polymer electrolyte membrane.

In this manner, a CCM was prepared.

### (Preparation of MEA)

### (Preparation of Anode Porous Substrate)

A carbon paper subjected to a water-repellent treatment (trade name “TGP-H-090”, approximately 300 μm in thickness, available from Toray Industries Inc.) was immersed in a diluted polytetrafluoroethylene (PTFE) dispersion (trade name “D-1”, available from Daikin Industries, Ltd.) for 1 minute. The carbon paper was then dried in a hot air dryer in which the temperature was set to 100° C. Subsequently, the dried carbon paper was baked at 270° C. in an electric furnace for 2 hours. In this manner, an anode porous substrate with a PTFE content of 10% by weight was produced.

### (Preparation of Cathode Porous Substrate)

A cathode porous substrate with a PTFE content of 10% by weight was produced in the same manner as the anode porous substrate except for the use of a carbon cloth (trade name “AvCarb (trademark) 1071HCB”, available from Ballard Material Products Inc.) in place of the carbon paper subjected to a water-repellent treatment.

### (Preparation of Anode Water-Repellent Layer)

An acetylene black powder and a PTFE dispersion (trade name “D-1” available from Daikin Industries, Ltd.) were stirred and mixed with a stirring device to prepare an ink for forming a water-repellent layer having a PTFE content of 10% by weight of the total solid content and an acetylene black content of 90% by weight of the total solid content. The water-repellent-layer forming ink was sprayed onto one surface of the anode porous substrate by a spray method using an air brush. The sprayed ink was then dried in a thermostat in which the temperature was set to 100° C. Subsequently, the anode porous substrate sprayed with the water-repellent-layer forming ink was baked at 270° C. in an electric furnace for 2 hours to remove the surfactant. In this manner, an anode water-repellent layer was formed on the anode porous substrate to produce an anode diffusion layer.

### (Preparation of Cathode Water-Repellent Layer)

A cathode water-repellent layer was formed on a surface of the cathode porous substrate in the same manner as the anode water-repellent layer, to produce a cathode diffusion layer.

The anode diffusion layer and the cathode diffusion layer were formed into a rectangle of 40×90 mm using a punching die.

Subsequently, the anode diffusion layer and the CCM were laminated so that the anode water-repellent layer was in contact with the anode catalyst layer. Also, the cathode diffusion layer and the CCM were laminated so that the cathode water-repellent layer was in contact with the cathode catalyst layer.

The resultant laminate was pressed with a pressure of 5 MPa for 1 minute, using a hot press machine in which the temperature was set to 125° C. In this manner, the anode catalyst layer and the anode diffusion layer were bonded, and the cathode catalyst layer and the cathode diffusion layer were bonded.

In the above manner, a membrane-electrode assembly (MEA) comprising the anode, the polymer electrolyte membrane, and the cathode was produced.

### (Arrangement of Gasket)

A 0.25-mm thick sheet of ethylene propylene diene rubber (EPDM) was cut to a rectangle of 50 mm×120 mm. Further, a central part thereof was cut off to form a rectangular opening of 42 mm×92 mm. In this manner, two gaskets were prepared.

The anode was fitted into the central opening of one of the gaskets, while the cathode was fitted into the central opening of the other gasket.

### (Preparation of Separator)

A rectangular resin-impregnated graphite plate with a thickness of 1.5 mm and a size of 50×120 mm was prepared as a material of an anode-side separator. The surface of the graphite plate was cut to form a fuel flow channel for supplying an aqueous methanol solution to the anode. One end (short side) of the separator was provided with an inlet (fuel inlet) of the fuel flow channel. The other end (short side) of the separator was provided with an outlet (fuel outlet) of the fuel flow channel. In this manner, the anode-side separator was prepared.

Likewise, a rectangular resin-impregnated graphite plate with a thickness of 2 mm and a size of 50×120 mm was prepared as a material of a cathode-side separator. The surface thereof was cut to form an air flow channel for supplying air to the cathode as the oxidant. One end (short side) of the separator was provided with an inlet (oxidant inlet) of the air flow channel. The other end (short side) of the separator was provided with an outlet (oxidant outlet) of the air flow channel. In this manner, the cathode-side separator was prepared.

The grooves of the fuel flow channel and the air flow channel had a width of 1 mm and a depth of 0.5 mm in cross-section. Also, the fuel flow channel and the air flow channel were of the serpentine type capable of uniformly supplying the fuel and air to the whole anode diffusion layer and the whole cathode diffusion layer.

The anode-side separator was laminated on the MEA so that the fuel flow channel was in contact with the anode diffusion layer. The cathode-side separator was laminated on the MEA so that the air flow channel was in contact with the cathode diffusion layer.

MEAs produced in the above manner, each sandwiched between the anode-side separator and the cathode-side separator, were stacked to form 10 cells, and both ends of the stack in the stacking direction were provided with a pair of end plates comprising 1-cm-thick stainless steel plates. A current collector plate comprising a 2-mm thick copper plate whose surface was plated with gold and an insulator plate were disposed between each end plate and each separator. The current collector plate was disposed on the separator side, while the insulator plate was disposed on the end plate side.

In this state, the pair of end plates was clamped with bolts, nuts, and springs to pressurize the MEAs and the respective separators.

In the above manner, a DMFC cell stack with a size of 50×120 mm was produced.

### (Preparation of Gas-Liquid Separation Mechanism)

A carbon sheet with a thickness of 4 mm and an average pore size of 0.6 mm, subjected to a hydrophilic treatment, was cut into a shape of 10 mm×35 mm to produce a porous filter. The contact angle between the porous filter and water was 10°.

A polypropylene resin casing in the shape of a container with an opening (first opening) having a shape corresponding to the porous filter was molded. A second opening (vent hole) of 3×35 mm was formed in the bottom of the casing close to one of the long sides. The porous filter was fitted into the casing so as to close the second opening from the inner side of the casing.

Subsequently, a 4-mm thick natural sponge sheet (water-absorbent material) was cut into a shape of 7 mm×35 mm, and fitted onto the porous filter so as not to overlap the second opening of the casing. In this manner, a filter portion was formed inside the casing. The face of the water-absorbent material on the first opening side was flush with the end of the casing defining the first opening. The region (first region) of the porous filter not covered with the water-absorbent material and the region (second region) covered with the water-absorbent material accounted for 30% and 70%, respectively.

A 2-mm diameter small hole was formed in a side face of the casing so as to face the sponge. From the small hole, a tubular nozzle was inserted into the sponge, and then the gap between the small hole and the nozzle was sealed. The circumference of the nozzle was provided with a plurality of water absorption holes for absorbing water. The end of the nozzle outside the casing was connected to a suction pump (PT09A-12-03) available from C. I. Kasei Co., Ltd.

### (Production of Fuel Cell System)

The fuel inlets of the respective cells disposed in an end face of the cell stack were connected to a fuel pump (personal pump NP-KX-100) of Nihon Seimitu Kagaku Co. Ltd. as a fuel supply portion. Specifically, a silicone tube was inserted into each of the fuel inlets of the respective cells, and these silicone tubes were joined by a branch pipe to form one flow channel. This flow channel was connected to the fuel pump.

The oxidant inlets disposed in the end face of the cell stack were connected to a high-pressure air cylinder for supplying compressed air, not a common air pump, as an oxidant supply portion, via a massflow controller of Horiba, Ltd. for adjusting the flow rate. Specifically, a silicone tube was inserted into each of the oxidant inlets of the respective cells, and these silicone tubes were joined by a branch pipe to form one flow channel. This flow channel was connected to the massflow controller.

The effluent tank used was a parallelepiped-shaped polypropylene container having a bottom face of 15×1 cm and a height of 3.5 cm. A porous film, TEMISH, available from Nitto Denko Corporation, was thermally welded to the upper face of the effluent tank as a gas-liquid separation film.

Upstream of the fuel pump, a mixing tank having a volume of 300 cm³ and made of polypropylene was disposed as a confluence portion. Upstream of the mixing tank, a fuel tank (cartridge) containing methanol as the supply fuel was connected. The effluent tank and the mixing tank were connected with a pipe, and the pipe was provided at some point with the same pump as the fuel pump of Nihon Seimitu Kagaku Co. Ltd. as a circulation pump.

Similarly to the inlets, a silicone tube was inserted into each of the fuel outlets of the respective cells disposed in another end face of the cell stack, and these silicone tubes were joined by a branch pipe to form one flow channel. This flow channel was connected to the effluent tank.

The oxidant outlets of the respective cells disposed in the same end face were directly connected with the first opening of the casing of the gas-liquid separation mechanism produced in the above manner, so that all the oxidant outlets were closed.

Also, the outlet side of the suction pump connected to the nozzle inserted into the sponge within the gas-liquid separation mechanism was connected to the effluent tank with a pipe. In this manner, a product water discharge path comprising the nozzle, the suction pump, and the pipe was formed.

### [Evaluation]

The outputs of the fuel pump, the circulation pump, and the suction pump were controlled by a micro computer. Specifically, output parameters such as the fuel pump were determined so that the fuel concentration in the mixing tank (confluence portion) was constant, in order to control them.

Due to the control, a 4 mol/L aqueous methanol solution was supplied to the anodes at a flow rate of 10 cm³/min. Unhumidified air was supplied to the cathodes at a flow rate of 15000 cm³/min. The output terminals of the fuel cell were connected to an electronic load unit (PLZ164WA) of Kikusui Electronics Corporation via a DC/DC converter. Power was continuously generated at a constant current density of 200 mA/cm². As a result, no condensation occurred on the porous filter of the gas-liquid separation mechanism, and a good operation state was maintained.

As described above, the invention can suppress an increase in the loss of the pressure for supplying the oxidant to the cathodes.

### COMPARATIVE EXAMPLE 1

A gas-liquid separation mechanism was produced in the same manner as in Example 1 except that the whole surface of the porous filter (4-mm thick carbon sheet) was covered with the water-absorbent material (4-mm thick natural sponge sheet). Using this, a fuel cell system was produced in the same manner as in Example 1, and evaluated in the same manner. As a result, during the continuous power generation, the water-absorbent material covering the whole surface of the porous filter became impregnated with water, thereby making it difficult for the air to flow. As such, the pressure loss in the cathodes increased. However, condensation did not occur on the porous filter.

### COMPARATIVE EXAMPLE 2

A gas-liquid separation mechanism was produced in the same manner as in Example 1 except that only the porous filter was used and that no water-absorbent material was used. Using this, a fuel cell system was produced in the same manner as in Example 1, and evaluated in the same manner. In this comparative example, since the flexibility of the carbon sheet was insufficient, it was difficult to fit the porous filter closely to the vent hole of the casing. As a result, the pressure loss in the cathodes decreased, but the cathode product water discharged from the oxidant outlets could not be efficiently collected by the gas-liquid separation mechanism. Thus, condensation occurred, causing the cell voltage to lower.

### INDUSTRIAL APPLICABILITY

The fuel cell system of the invention is useful, for example, as the power source for portable small electronic appliances such as notebook personal computers, cellular phones, and personal digital assistants (PDAs). Also, the fuel cell system of the invention is applicable to uses including the power source for electric scooters.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1 Fuel Cell System
2 Fuel Cell
2b Fuel Inlet
2c Fuel Outlet
2d Oxidant Inlet
2e Oxidant Outlet
3 Fuel Pump
4 Air Pump
5 Control Unit
6 Fuel Tank
7 Effluent Tank
8 Confluence portion
100 Gas-Liquid Separation Mechanism
101 Product Water Discharge Path
102 Dc/Dc Converter
103 Storage Battery
104 Vent Hole
105 Porous Filter
106 Water-Absorbent Material
107 Casing
107a First Opening
111 Suction Pump
112 Nozzle

1. A direct oxidation fuel cell system comprising:
a fuel cell comprising at least one cell, a fuel inlet for introducing a liquid fuel, a fuel outlet for discharging a fuel effluent, an oxidant inlet for introducing an oxidant, and an oxidant outlet for discharging a fluid containing unconsumed oxidant and product water;
a fuel supply portion for supplying the liquid fuel to the fuel inlet;
an oxidant supply portion for supplying the oxidant to the oxidant inlet;
an effluent tank for storing the fuel effluent and a part of the product water;
a fuel discharge path for leading the fuel effluent to the effluent tank;
a gas-liquid separation mechanism for separating a part of the product water from the fluid and discharging the remainder to outside; and
a product water discharge path for leading the separated product water to the effluent tank,
wherein the gas-liquid separation mechanism has: a vent hole communicating with the oxidant outlet and outside; a porous filter for closing the vent hole; and a water-absorbent material for partially covering the surface of the porous filter on the oxidant outlet side.

2. The direct oxidation fuel cell system in accordance with claim 1, wherein the porous filter has pores with an average pore size of 0.4 to 1.2 mm.

3. The direct oxidation fuel cell system in accordance with claim 1, wherein the porous filter comprises a carbon sheet.

4. The direct oxidation fuel cell system in accordance with claim 3, wherein the carbon sheet is hydrophilic.

5. The direct oxidation fuel cell system in accordance with claim 1, wherein the water-absorbent material covers 60 to 90% of the surface of the porous filter on the oxidant outlet side.

6. The direct oxidation fuel cell system in accordance with claim 1, wherein the product water discharge path is equipped with a suction pump for sucking the product water held in the water-absorbent material.

7. The direct oxidation fuel cell system in accordance with any claim 1, wherein the fuel supply portion includes: a circulation pump for circulating the fuel effluent diluted with the product water from the effluent tank to the fuel inlet; a fuel tank for storing a supply fuel; and a confluence portion where the supply fuel supplied from the fuel tank and the diluted fuel effluent are joined.
